(19) United States
(12) Patent Application Publication
(10) Pub. No.: US 2012/0186153 A1
(43) Pub. Date: Jul. 26, 2012

(54) DEVICE, SYSTEM AND METHODS FOR HYDROPONIC GARDENING

(75) Inventor: Treg Bradley, Scottsdale, AZ (US)

(73) Assignee: American Agritech, L.L.C., Chandler, AZ (US)

(21) Appl. No.: 13/359,380

(22) Filed: Jan. 26, 2012

Related U.S. Application Data
(60) Provisional application No. 61/436,431, filed on Jan. 26, 2011.

(51) Int. Cl. A01G 31/02; A01G 31/00

(52) U.S. Cl. 47/60; 47/59 R

(57) ABSTRACT

In accordance with exemplary embodiments, the present disclosure comprises a device, system and methods for water and/or nutrient-efficient hydroponic gardening. In accordance with exemplary embodiments, the device comprises a grow cup which allows plants to develop and grow roots in one or more of a hydrozone, an aerozone, and a biozone. A system in accordance with exemplary embodiments of the present disclosure comprises a grow cup within a tray. Exemplary methods of enhanced hydroponic gardening comprise providing a grow cup, adding one or more grow media to each of a hydrozone, an aerozone, and a biozone within the grow cup, submersing the hydrozone in a highly oxygenated water and/or nutrient solution, and planting a plant in the biozone.

### CROSS-REFERENCE TO RELATED APPLICATIONS

This application is a non-provisional of and claims priority to U.S. Provisional No. 61/436,431 filed on Jan. 26, 2011 and entitled “Device, System and Methods for Hydroponic Gardening”, wherein such provisional application is hereby incorporated by reference in its entirety,

### FIELD OF INVENTION

The present disclosure generally relates to growing plants, and more particularly, to a device, system and methods for improved hydroponic gardening.

### BACKGROUND OF THE INVENTION

In the field of growing plants, one common method used is known as hydroponics (or the soil-less growth of plants), which comprises the cultivation of plants by placing the roots in a nutrient solution rather than in soil. In some instances a light soil or similar material (e.g. peat moss or even some man made materials) may be used to hold the roots, but the primary nutrients are provided by solutions that are either added or in which the roots actually reside.

One major concern with this method of growing plants is the amount of area and equipment that is required. In some instances, a completely separate building is required with light and temperature control as well as containers for holding the plants and the nutrient solutions. This can be costly for start-up companies and can severely limit the people who can participate, since much of this type of growing can take place in cities or highly populated areas where there is insufficient area for standard farming techniques and, thus, limited area he installation of normal hydroponics-type growing.

While a large variety of hydroponics systems and methods of use are available or have been proposed, these systems have serious limitations. One problem that arises in many of the existing hydroponics devices is improper lighting. In many of the existing plant growth units, different types and amounts of light may be received by the plants in different positions. The differences in light quality and quantity may result in a divergence in growth and quality between plants grown at various levels and on various sides of the plant growth units.

In many instances, people would like to grow only a few plants and would like to place them in convenient locations. For example, in many instances people like several plants standing around their living area or, if weather permits, outside on a patio or veranda. In this day, many people are too busy to provide proper care for the plants and, consequently, they find maintaining the plants very difficult.

### SUMMARY OF THE INVENTION

In accordance with exemplary embodiments, the present disclosure comprises a device, system and methods for water and/or nutrient-efficient hydroponic gardening.

Exemplary embodiments of the present disclosure utilize a multi root zone platform contained within a grow cup. In accordance with exemplary embodiments, the grow cup allows plants to develop and grow roots in one or more of a hydrozone, an aerozone, and a biozone.

In accordance with exemplary embodiments, the hydrozone of the grow cup is partially or fully submerged in an aqueous solution, such as a highly oxygenated water and/or nutrient solution. The aerozone of he grow cup allows roots to grow out of one or more openings in the side of the grow cup to facilitate passage and/or transport of an increased level of oxygen or other desired gas to the plant roots and the growing media. In accordance with exemplary embodiments, the biozone area of the grow cup does not contain any, or contains substantially fewer, openings and therefore will contain the roots and direct them downward. The biozone allows for the inoculation and colonization of beneficial bacteria and fungi keeping a natural symbiotic relationship with the roots,

A system in accordance with exemplary embodiments of the present disclosure comprises: (i) a grow cup, (ii) a tray, and optionally, one or more of: (iii) a lid, (iv) a pump, (v) a reservoir, (vi) an overflow mechanism, and (vii) an air supply.

Methods of enhanced hydroponic gardening comprise providing a grow cup comprising a hydrozone, an aerozone, and a biozone and at least partially submersing the hydrozone in a highly oxygenated water and/or nutrient solution in order to grow a plant.

### BRIEF DESCRIPTION OF THE DRAWINGS

The exemplary embodiments of the present disclosure will be described in conjunction with the accompanying drawing FIGS. in which like numerals denote like elements and:

FIG. 1 illustrates a block diagram of a grow cup in accordance with an exemplary embodiment of the present disclosure;

FIGS. 2A and 2B illustrate commercial embodiments of grow cups in accordance with exemplary embodiments of the present disclosure;

FIG. 2C illustrates an adapter collar assembly in accordance with an exemplary embodiment of the present disclosure;

FIG. 3 illustrates a system in accordance with an exemplary embodiment of the present disclosure;

FIGS. 4A and 4B each illustrate a system comprising multiple grow cups in accordance with exemplary embodiments of the present disclosure;

FIG. 5 illustrates a commercial embodiment of a system comprising multiple grow cups in accordance with an exemplary embodiment of the present disclosure; and

FIG. 6 illustrates a system comprising multiple trays arranged in a staircase manner in accordance with an exemplary embodiment of the present disclosure,

### DETAILED DESCRIPTION

In accordance with exemplary embodiments, the present disclosure comprises a device, system and methods for hydroponic gardening. Persons skilled in the art will readily appreciate that various aspects of the invention may be realized by any number of methods and devices configured to perform the intended functions. Stated differently, other methods and devices may be incorporated herein to perform the intended functions. It should also be noted that the drawing figures (“FIGS. ”) referred to herein are not all drawn to scale, but may be exaggerated to illustrate various aspects of the invention, and in that regard, the drawing FIGS. should not be construed as limiting. Finally, although the present disclosure may be described in connection with various hydroponic principles and beliefs, the present disclosure should not be bound by theory.

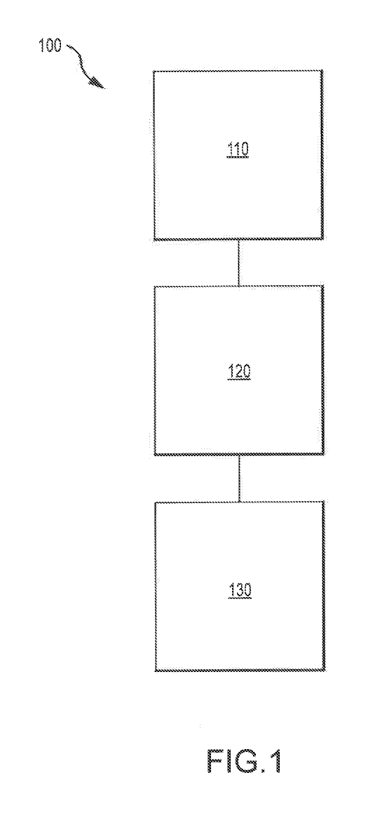

Exemplary embodiments of the present disclosure utilize a multi root zone platform contained within a grow cup. An exemplary grow cup is structured to facilitate the function of each root zone. The grow cup allows plants to develop and grow roots in one or more of a plurality of zones. By way of example, and with reference to FIG. 1, a grow cup 100 allows plants to develop and grow roots in at least two of a first zone 110, a second zone 120, and a third zone 130.

In exemplary embodiments, different zones of grow cup 100 can be integrally molded or bonded. In other embodiments, different zones of grow cup 100 are coupled to each other via bolts, dowels, welding, soldering, brazing, sleeves, brackets, clips, clamps, threads, adhesives, or other devices or configurations known in the art or hereinafter developed to couple components. The coupling may be permanent or temporary, and the coupling may include an adjustable coupling, thereby allowing the components to be extended away from each other or closer to each other, for example, in a telescoping manner.

Exemplary embodiments of the present disclosure can comprise a plurality of zones spatially configured such that overall, grow cup 100 is tapered and thereby stackable, for ease of shipping and storage for example. Moreover, exemplary grow cups 100 can comprise a circular cross-section, yet other cross-section shapes are contemplated, for example, ovals, squares, rectangles, triangles, and decorative shapes such as stars, to name just a few.

Proportionally, exemplary embodiments of grow cup 100 can comprise an average circular diameter that is less than about 75% of the overall height of grow cup 100, and more preferably, equal to or less than about 50% of the overall height of grow cup 100. For instance, exemplary grow cups 100 may have dimensions (diameter×height) of approximately 5 in×12 in, 4 in×8 in or 2.5 in×5 in. However, numerous other configurations of dimensions for grow cup 100 are contemplated.

Similarly, exemplary embodiments can comprise grow cup 100 having a diameter at the bottom that is less than about 90% of the diameter at the top of grow cup 100, and more preferably, less than about 80% of the diameter at the top. In exemplary embodiments, the height of the different zones of grow cup 100 are equivalent or substantially similar, while in other embodiments, the heights of the different zones vary between zones.

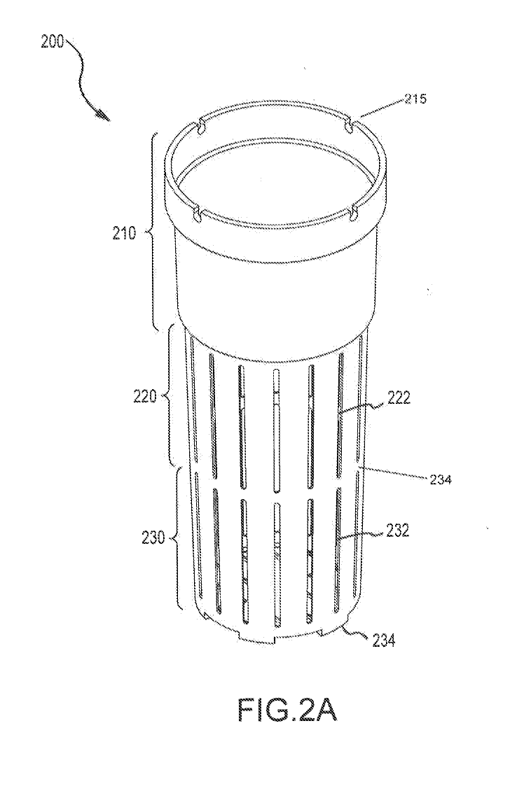

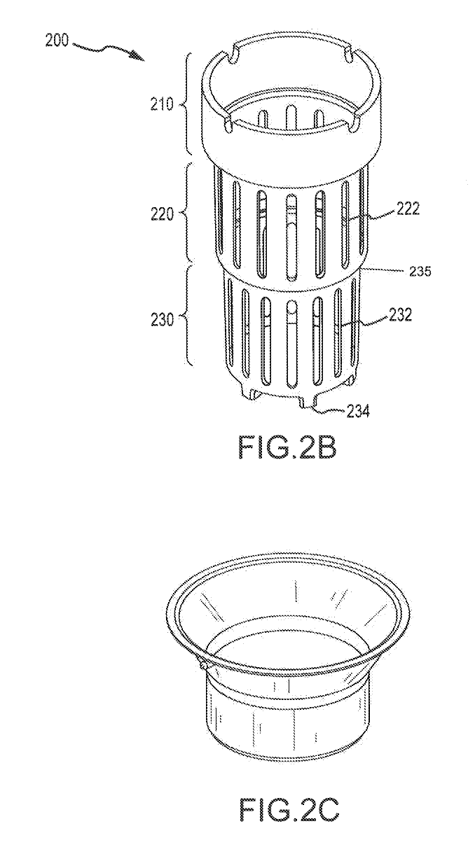

In accordance with exemplary embodiments, and with reference to FIGS. 2A and 2B, a grow cup 200 allows plants to develop and grow roots in at least one, and more preferably at least two of three root zones. Exemplary root zones can comprise an aerozone 220, wherein roots reside in a gaseous or aerated environment whether controlled or uncontrolled; a biozone 210, wherein roots are exposed to beneficial microorganisms or fungi to improve plant health; or a hydrozone 230, wherein roots are temporarily or permanently submersed in an aqueous solution, such as a highly oxygenated water and/or nutrient solution. An exemplary embodiment may comprise grow cup 200 containing hydrozone 230 and aerozone 220, but no biozone 210. Similarly, a region of grow cup 200 can also alternate between zones, such as between a hydrozone 230 and an aerozone 22.

In exemplary embodiments, hydrozone 230 allows water roots to grow out of one or more windows, such as slits or portholes, in the side and/or base of grow cup 200 and growing media to hydrate and feed and grow a large root mass for efficient nutrient assimilation. A window comprises an opening in the wall of grow cup 200 that permits air, liquid, or roots to pass therethrough. In exemplary embodiments, hydrozone 230 comprises a plurality of windows 232 about the perimeter of grow cup 200 so that the adequate amount of oxygenated water and/or nutrient solution accesses the root system. Any number of openings may be suitable for use with the present disclosure, for example, 2, 3, 4, 5, 8, 16, 24, 32, or more, and exemplary openings may be any suitable size or shape, and may be the same as or different from adjacent openings. However, the preferred percentage of open space surface area in the hydrozone is the percentage which provides the preferred amount of flow of solution to the root system so that the plant is not over-watered and also provides a preferred amount of structural support so that a growing root system, or the weight of an above located zone, does not damage the cup. For example, the plurality of windows 232 may amount to a surface area percentage of between 5-75%, preferably between about 15-30%. These numbers are provided as examples and should not be construed to limit the scope of the disclosure. In accordance with exemplary embodiments, hydrozone 230 can be at least 20% of, the total height of grow cup 200, more preferably about ⅓ of the height of grow cup 200, however, and as discussed above, the heights of the different zones vary.

In exemplary embodiments, grow cup 200 is optionally configured with one or more standoffs 234 to provide stability to grow cup 200 and/or to provide access to one or more openings in or near the base of grow cup 200. Standoffs 234 may be on the base of hydrozone 230 or alternatively, projecting from aerozone 220 or biozone 210. Each standoff 234 can also comprises an opening or window in the bottom thereof to further improve access.

In exemplary embodiments, grow cup 200 may comprise a transition line 235 or visual mark to serve as a visual aid to indicate the preferred level of the aqueous solution, i.e., the junction between the aerozone 220 and hydrozone 230. Transition line 235 as depicted in FIG. 2A is structurally created by separating the plurality of windows 222,232 in each zone 220,230.

In accordance with exemplary embodiments, aerozone 220 of grow cup 200 allows air roots to grow out of one or more openings in the side of grow cup 200 to achieve an increased level of oxygen or other desired gas to the growing media and to the plant roots.

In exemplary embodiments, aerozone 220 comprises a plurality of windows 222 about the perimeter of grow cup 200. Any number of openings may be suitable for use with the present disclosure, for example, 2, 3, 4, 5, 8, 16, 24, 32, or more, and exemplary openings may be any suitable size or shape, and may be the same as or different from adjacent openings. However, the preferred percentage of open space surface area in hydrozone 230 is the percentage which provides the preferred amount of air flow to the root system and grow media so that the beneficial microbes and fungi located in aerozone 220 and biozone 210 receive increased oxygen and also provides a preferred amount of structural support so that a growing root, or the weight of a growing plant, does not damage the cup. For example, the plurality of windows 222 may amount to a surface area percentage of between 5-75%, preferably between about 15-30%. These numbers are provided as examples and should not be construed to limit the scope of the invention, except as set forth in the accompanying claims.

In exemplary embodiments, aerozone 220 will hold and facilitate an air to water ratio for improved plant health benefits. Aerozone 220 is preferably located above hydrozone 230 and below biozone 210. In accordance with exemplary embodiments, aerozone 220 can be at least 20% of the total height of grow cup 200, more preferably about ⅓ of the height of grow cup 200, however, and as discussed above, the heights of the different zones vary.

In exemplary embodiments, grow cup 200 can comprise a structural reinforcement 233. Such reinforcement 233 is locatable in aerozone and hydrozone region of grow cup 200 because plurality of windows 222, 232 can structurally weaken grow cup 200 and reinforcement 233 may be necessary. Structural reinforcement 233 can be integrated into grow cup 200 mold or a separate structure such as a clamp or gusset.

In exemplary embodiments, grow cup 200 can comprise at least one cutout or a groove 215 so that a drip line may be coupled thereto for added stability. A clip or any other suitable device can be used to stabilize a drip line or other attachment.

In accordance with exemplary embodiments, biozone 210 of grow cup 200 does not contain any, or contains substantially fewer, openings and therefore will contain the roots and direct them downward. Biozone 210 can allow for the inoculation and colonization of beneficial bacteria and fungi keeping a natural symbiotic relationship with the roots, thereby assisting in preventing root related diseases such as pythium and fusarium and allowing for a healthier crop than just utilizing sterile and inert medias in conventional hydroponics methods. Pythium and fusarium can be detrimental pathogens to a plant's overall health. In accordance with exemplary embodiments, biozone 210 can be at least 20% of the total height of grow cup 200, more preferably about ⅓ of the height of grow cup 200, however, and as discussed above, the heights of the different zones vary.

In accordance with an exemplary embodiment, grow cup 100 (or 200) can be comprised of any suitable material, such as a plastic like polyvinyl chloride (PVC). Other grow cup 100 embodiments may comprise a compostable material so that the plant can be easily transitioned from a hydroponic system into a soil environment. In exemplary embodiments, different zones of grow cup 100 can be comprised of the same material, while in other embodiments, different zones can be comprised of different materials. For example, a hydrozone 130 may comprise a material more durable when exposed to highly humid environment than may be required for biozone 110 or aerozone 120. Exemplary materials may be water resistant, porous, non-porous, or otherwise. In general, any suitable grow cup material may be selected based on, inter alia, the lightness, strength, ease of manufacture, functionality, and/or any other design criteria or specification. Such materials can comprise one or more of a plastic, alloy, rubber, composite, bio-absorbable, compostable, or a biodegradable material, and the like,

In accordance with exemplary embodiments, the various grow cups 200 may be used in systems to cultivate plants and/or propagate seedlings, or in connection with a nursery or the like. In exemplary embodiments, grow cups 200 containing plants may be transplanted to other hydroponic systems or into soil mediums,

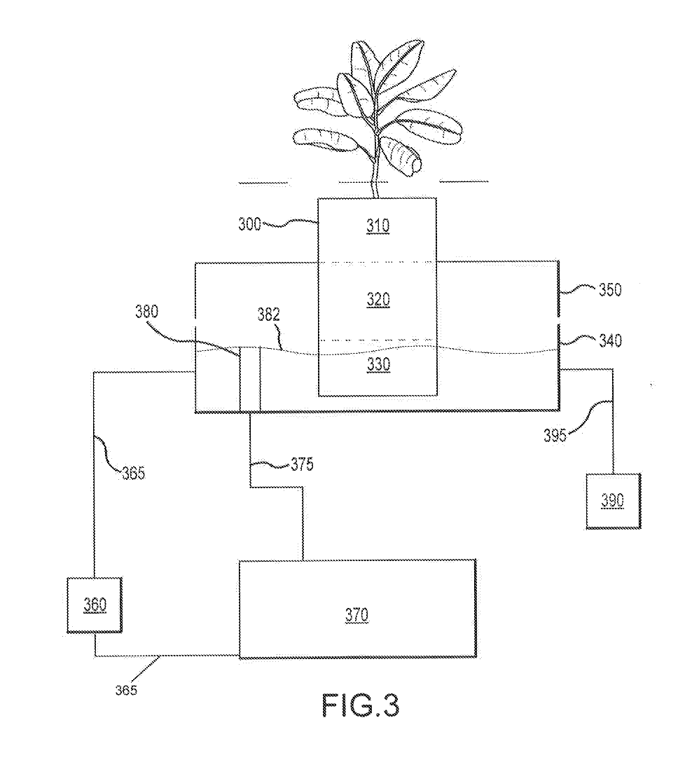

A system in accordance with exemplary embodiments of the present disclosure comprises: (i) a grow cup, as described above, (ii) a tray, and optionally, one or more of: (iii) a lid, (iv) a pump, (v) a reservoir, (vi) an overflow mechanism, and (vii) an air supply. Each of these individual components will now be described in turn, with reference to FIG. 3.

A system in accordance with exemplary embodiments of the present disclosure comprises a tray 340 within which to at least partially submerse a hydrozone 330 of a grow cup 300. In exemplary embodiments, tray 340 is configured to store an aqueous solution, such as a highly oxygenated water and/or a nutrient solution. In exemplary embodiments, tray 340 comprises various access portholes, fittings, plumbings and/or couplings for one or more irrigation lines and nozzles, pumps, reservoirs, overflow fittings, and jets, which may be located in the bottom and/or sides of tray 340.

In exemplary embodiments, tray 340 has about a 2-10 inch depth, and more preferably about a 5 inch depth. In exemplary embodiments, tray 340 is about 4-16 inches in width, and more preferably is about 8 inches in width. In exemplary embodiments, tray 340 is over about 2 ft, and more preferably, over about 4 ft in length. While dimensions are provided, persons skilled in the art will readily appreciate that the present disclosure should not be construed as limited by the dimensions set forth herein, but rather, by the structural configurations themselves.

A system in accordance with exemplary embodiments of the present disclosure optionally comprises a lid 350 to stabilize grow cup 300. In addition, lid 350 can be configured to at least partially enclose an aerozone 320, and optionally, some or all of a biozone 310. In exemplary embodiments, lid 350 comprises one or more openings configured to support one or more grow cups 300 on or within the tray 340 and lid 350 assembly. By way of example, a grow cup 300 may comprise a lip having a width (or diameter) just greater than the width of the corresponding opening in lid 350. In another embodiment, a grow cup 300 does not comprise a lip, but the width of a grow cup 300 at the desired support height is just greater than the width of the corresponding opening in lid 350.

In exemplary embodiments, a grow cup 300 can comprise an adapter collar assembly designed to accompany various sizes of grow cups 300 and allow a single hole size to be drilled into lid 350 with the adapter maintaining the height of hydrozone 330 in contact with the nutrient solution. Alternatively, lid 350 may be retrofitted with an adapter collar. An exemplary adapter collar assembly is illustrated in FIG. 2C, however, persons skilled in the art will readily appreciate that numerous configurations are possible. An exemplary adapter collar assembly effectively reduces the width of the orifice to accommodate a narrow width or small grow cups 300 and can also be configured to lower the grow cup 300 into tray 340 and ensure the desired level of submersion of hydrozone 330 within the solution.

Accordingly, beginning with a smaller grow cup 300 and an adapted collar assembly, a grower can choose to plant a seedling, germinate a seed, or cultivate a cutting or clone (each of the foregoing and the like referred to as a “plant” herein). Once the plant reaches the next phase of growth, the smaller grow cup 300 can be placed directly into a larger grow cup 300 due to the windows or openings allowing the roots to escape the confines of the smaller grow cup 300, or the plant can be removed from the smaller grow cup 300 for transplanting as desired. A benefit of this transplant technique is to minimize damage to the root structure and subsequently limit the possibility of disease due to wounds in the roots. The design also allows the grower to use the same system for all phases of growth without needing to modify lid 350 or use a larger grow cup 300 filled with excessive media for the particular phase of growth.

In exemplary embodiments, lid 350 can be configured to create a headspace within the interior of the combined lid 350 and tray 340. The headspace can at least partially span the aerozone 320. The lid can protect the roots from light, which can be harmful to roots. In addition, the lid maintains an increasingly humid and/or oxygenated atmosphere within the headspace, which can be beneficial to the roots and the microorganisms and fungi.

In exemplary embodiments, lid 350 has about a 1-6 in depth, and more preferably about a 3 in depth. In exemplary embodiments, lid 350 is about 4-6 in in width, and more preferably is about 8 in in width. In exemplary embodiments, lid 350 is over about 2 ft, and more preferably, over about 4 ft in length. As noted above, persons skilled in the art will readily appreciate however, that the present disclosure should not be construed as limited by the dimensions set forth herein, but rather, by the structural configurations themselves.

Lid 350 can be configured to rest upon or mate with tray 340 or couple thereto. In exemplary embodiments, tray 340 and lid 350 cooperate to form a unitary structure Optionally, lid 350 and tray 340 can be integrally molded or bonded to each other. Such structure can be any shape, whether regular or irregular, for example, a prism, sphere or hemisphere or cooperate to form a frustoconical (e.g., a volcano shape), cylindrical or star shaped. Tray 340 and lid 350, in exemplary embodiments, are coupled to each other via hinges, bolts, dowels, welding, soldering, brazing, sleeves, brackets, clips, clamps, threads, or other devices or configurations known in the art or hereinafter developed. The coupling may be permanent or temporary, and the coupling may include an adjustable coupling, thereby allowing the lid 340 and tray 340 to be extended away from each other or closer to each other, for example, in a telescoping manner.

A system in accordance with exemplary embodiments of the present disclosure, with reference to FIG. 3, optionally comprises a pump 360. While depicted as connected to tray 340 and a reservoir 370 via irrigation lines 365, persons skilled in the art will readily appreciate that pump 360 may be co-housed within either of tray 340 and reservoir 370. In exemplary embodiments, pump 360 is an electric pump, powered externally or with batteries. In general, any method or device configured to facilitate the delivery of an aqueous and/or a nutrient solution from reservoir 370 to tray 340 is suitable for use herein. By way of illustration, pump 360 can be a gravity driven pressure gradient and an adjustable valve configured to facilitate the delivery of aqueous and/or a nutrient solution from reservoir 370 to tray 340.

As noted, a system in accordance with exemplary embodiments of the present disclosure optionally comprises reservoir 370. In exemplary embodiments, reservoir 370 is configured to store an aqueous and/or a nutrient solution. While depicted as connected to tray 340 via irrigation lines 365, persons skilled in the art will readily appreciate that reservoir 370 may supply water to tray 340 in other configurations. In an exemplary embodiment, not shown in the FIGS., reservoir 370 is located above tray 340. In accordance with one aspect of an exemplary embodiment, this eliminates the need for pump 360. In another exemplary embodiment, reservoir 370 is located below tray 340. While the size and dimensions of reservoir 370 can vary depending on the particular use, in exemplary embodiments, reservoir 370 holds 10, 20, 40, 70, 115 or more gallons of an aqueous and/or a nutrient solution.

A system in accordance with exemplary embodiments of the present disclosure optionally comprises an overflow mechanism. In general, an overflow mechanism is generally any method or device configured to regulate the volume of the aqueous and/or nutrient solution within tray 340. In an exemplary embodiment, tray 340 is plumbed with an overflow mechanism comprised of an overflow fitting 380 to allow for a deep flow of nutrient rich solution. With reference to FIG. 3, when the water or nutrient rich solution level 382 is above the top of overflow fitting 380, overflow fitting 380 acts as a drain to reservoir 370 via an irrigation line 375 plumbed at or near the bottom of tray 340.

Finally, a system in accordance with exemplary embodiments of the present disclosure may optionally comprise an air supply 390, shown in FIG. 3 as coupled to tray 340 via an air line 395. In exemplary embodiments, tray 340 incorporates air lines with air stones. In exemplary embodiments, tray 340 is equipped with jets to highly agitate the water or nutrient rich solution to thereby maximize the levels of dissolved oxygen available to the root system or other desired gas or gas mixture.

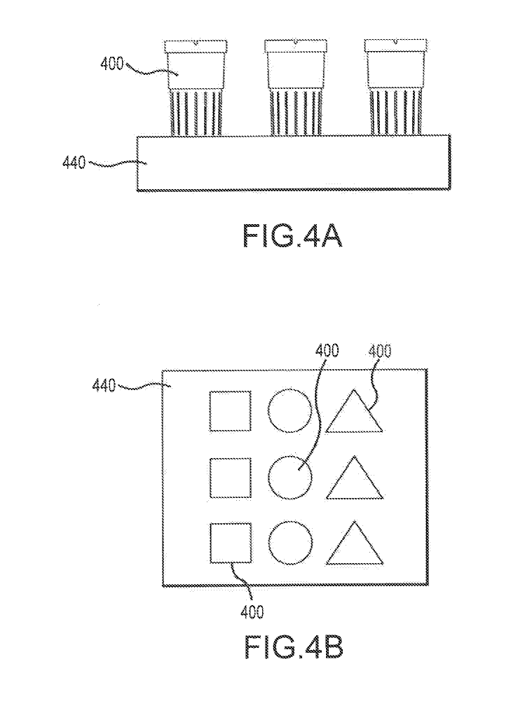

In exemplary embodiments, a tray comprises a single grow cup. Alternatively, and with brief reference to FIGS. 4A and 4B, a tray 440 may comprise a plurality of grow cups 400 arranged in tray 440 in series and/or in parallel. In one embodiment, tray 440 is available with two, three, four, five, six, eight, ten, or more grow cups.

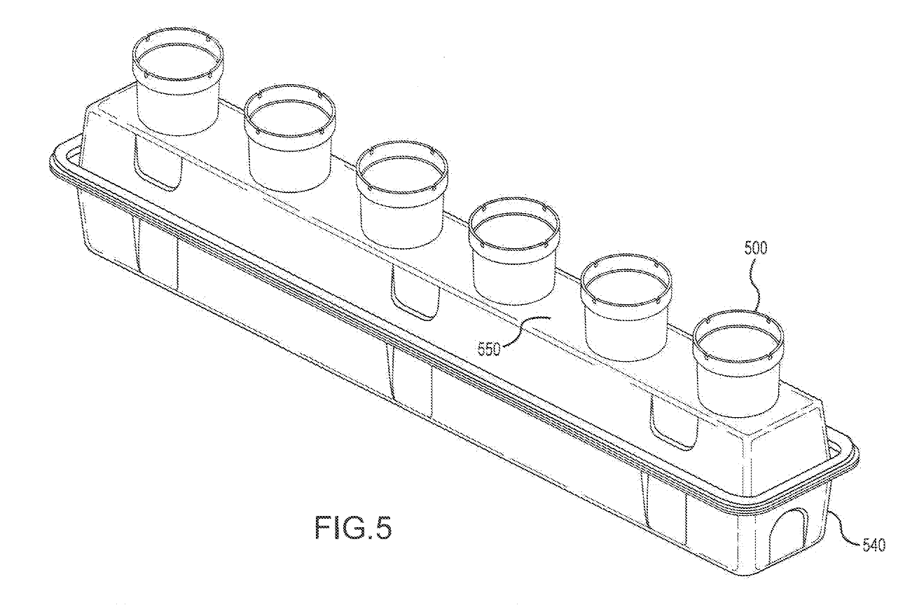

Similarly, FIG. 5 illustrates a commercial embodiment of a tray 540 and a lid 550 comprising six grow cups 500 arranged in series. In one embodiment, lid 550 may be used in an inverted and/or reversed manner and may contain an access porthole and/or porthole cover.

Referring back to FIGS. 4A and 4B, in exemplary embodiments, a gravity feed configuration may allow a control reservoir to supply tray 440 with a nutrient solution or water via irrigation lines and bulk head fittings. Tray 440 may contain a float valve, drain fittings, or other structures to ensure an optimal volume of nutrient solution or water is contained within tray 440. In another embodiment, the control reservoir may utilize a lid and may incorporate a porthole and/or porthole cover. In another embodiment, tray 440 may be supplied with a nutrient solution or water from the control reservoir, via irrigation lines and one or more secondary flow pumps, that is, either independent or interconnected to tray 440.

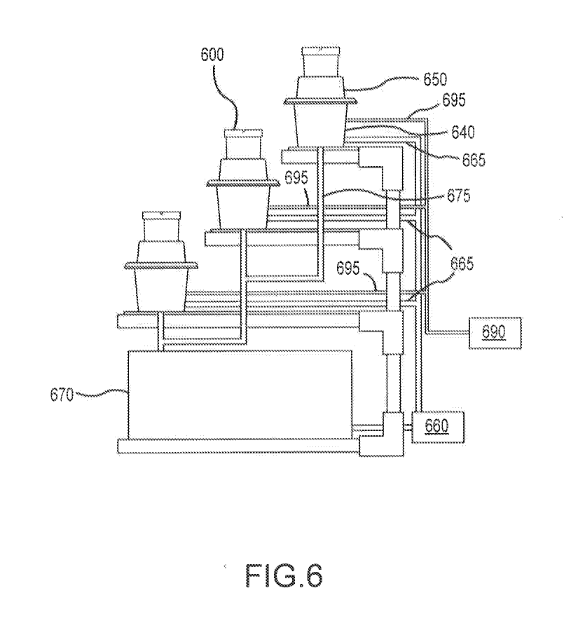

Moreover, a system may comprise a plurality of trays, each of which may comprise a plurality of grow cups arranged in each of the trays in series and/or in parallel. To illustrate, the system shown in FIG. 6 comprises: (i) grow cups 600, (ii) trays 640, (iii) lids 650, (iv) a pump 660 and its associated conduits 665, (v) a reservoir 670, (vi) overflow mechanisms (not shown) and their associated conduits 675, and (vii) an air supply 690 and its associated conduits 695. In this embodiment, trays 640 are arranged in a staircase or stepped manner for space saving or light quality or quantity, however, persons skilled in the art will readily appreciate that other configurations would also suffice.

Methods of enhanced hydroponic gardening comprise one or more of the following steps: (i) providing a grow cup comprising a hydrozone, an aerozone, and a biozone; (ii) adding one or more grow media to each of the hydrozone, the aerozone, and the biozone; (iii) at least partially submersing the hydrozone in a highly oxygenated water and/or nutrient solution; and (iv) placing a plant in the biozone. The grow cup may be placed in a tray containing highly oxygenated water and/or nutrient solution, the tray may be covered with a lid such that the biozone at least partially sits above the lid and the aerozone at least partially resides in the headspace, and the hydrozone at least partially resides in the solution Additional steps may comprise inoculating the grow media with beneficial microorganisms and/or fungi; aerating the nutrient solution with oxygen or another desired gas to increase concentration of desired gas within the nutrient solution and the headspace.

Exemplary growing media may comprise any soil-less substrate known in the art or hereinafter developed. Exemplary grow media may comprise all natural and organic ingredients containing an optimum air to water ratio for superior growth rates and yields compared to conventional potting soils. Exemplary grow media may comprise coir fiber, peat moss, oasis cubes, expanded clay pellets, rockwool, coconut fiber, sand, gravel, perlite, pumice, aggregate rock, zeolite, sphagnum moss, vermiculite, fiberglass insulation, saw dust, and lava rock. Notwithstanding the foregoing, other grow media and even conventional potting soils may be used in connection with the present disclosure.

Exemplary embodiments of the present disclosure assist plants to achieve accelerated growth rates, crop cycles, and yields utilizing hydroponics technology and organic growing methods heretofore unknown among persons skilled in the art. With exemplary embodiments of the present disclosure, hydroponic gardeners can now harness both science and nature to produce unexpected results. Exemplary embodiments of the present disclosure can be used by hobbyist gardeners, advanced gardeners, horticulture students, research laboratories as well as commercial growers alike.

The present disclosure has been described above with reference to various exemplary embodiments. However, those skilled in the art will recognize that changes and modifications may be made to the exemplary embodiments without departing from the scope of the present disclosure. For example, the various components and structure, as well as any operational steps, may be implemented in alternate ways depending upon the particular application or in consideration of any number of cost functions associated with the operation of the system, e.g., various of the components and methodologies or steps may be deleted, modified, or combined with other components, methodologies and/or steps. These and other functions, methods, changes or modifications are intended to be included within the scope of the present disclosure, as set forth in the following claims.

We claim:

1. A grow cup for hydroponic gardening comprising:
a hydrozone containing a plurality of windows in the perimeter and the base thereof;
an aerozone containing a plurality of windows in the perimeter thereof; and
a biozone not containing windows in the perimeter thereof;
wherein the aerozone is located below the biozone and above the hydrozone;

2. A grow cup for hydroponic gardening as in claim 1, wherein the hydrozone is configured with one or more standoffs on the base of the hydrozone.

3. A grow cup for hydroponic gardening as in claim 2, wherein each of the one or more standoffs comprises a window in the bottom thereof,

4. A grow cup for hydroponic gardening as in claim 1, wherein the biozone comprises at least 25% of the grow cup height.

5. A grow cup for hydroponic gardening as in claim 1, wherein each zone comprises about ⅓ of the grow cup height.

6. A grow cup for hydroponic gardening as in claim 5, further comprising a groove configured to receive a drip line,

7. A grow cup for hydroponic gardening as in claim 5, further comprising a lip configured to rest upon a lid locatable between the biozone and the aerozone,

8. A grow cup for hydroponic gardening as in claim 1, wherein the surface area of the plurality of windows located in the hydrozone is between about 15 to 30% of the total hydrozone surface area,

9. A grow cup for hydroponic gardening as in claim 9, wherein the surface area of the plurality of windows located in the aerozone is between about 15 to 30% of the total aerozone surface area.

10. A grow cup for hydroponic gardening as in claim 1, further comprising a collared adapter.

11. A system for hydroponic gardening comprising
a grow cup comprising a hydrozone, an aerozone, and a biozone;
a tray configured to contain a nutrient solution wherein the hydrozone can be at least partially submersed therein; and
a lid configured to create a headspace above the nutrient solution.

12. A system for hydroponic gardening as in claim 10 further comprising one or more of a pump, a reservoir, an overflow mechanism, and an air supply.

13. A system for hydroponic gardening as in claim 11, wherein the air supply is configured to highly agitate the nutrient solution to thereby enhance the levels of dissolved oxygen therein.

14. A system for hydroponic gardening as in claim 10, comprising a plurality of grow cups within the tray, wherein the hydrozone of each can be at least partially submersed in the nutrient solution within the tray.

15. A system for hydroponic gardening as in claim 10, wherein the biozone is located above the lid.

16. A system of hydroponic gardening as in claim 10, wherein the nutrient solution level does not go beyond the hydrozone.

17. A grow cup for hydroponic gardening as in claim 16, wherein each zone comprises at least 25% of the grow cup height.

18. A method for hydroponic gardening comprising:
providing a grow cup comprising a hydrozone, an aerozone, and a biozone, wherein the hydrozone is at least partially submersed in a nutrient solution within a tray;
adding a grow media to each of the hydrozone, the aerozone, and the biozone; and
placing a plant in the biozone.

19. A method for hydroponic gardening as in claim 18, wherein a lid is located over the tray such that the biozone is located above the lid,

20. A method for hydroponic gardening as in claim 18, further comprising aerating the nutrient solution to increase the oxygen concentration within the nutrient solution and a headspace, wherein the headspace spans at least part of the aerozone.
